(19) United States
(12) Patent Application Publication
(10) Pub. No.: US 2003/0108005 A1
(43) Pub. Date: Jun. 12, 2003

(54) Frequency hop collision avoidance in a multi-channel, bluetooth-enabled packet transmission system

(76) Inventors: Prathima Agrawal, New Providence, NJ (US); David Famolari, Montclair, NJ (US)

Correspondence Address: Joseph Giordano, Esq., Telcordia Technologies, Inc., 445 South Street, Room 1G-112R, Morristown, NJ, 07960, US

(21) Appl. No.: 10/016,099

(22) Filed: Dec. 10, 2001

(51) Int. Cl. H04Q 7/00

(52) U.S. Cl. 370/329; 370/349

(57) ABSTRACT

An arrangement is described for aborting predicted collisions between independent FH-CDMA channel hopping patterns on separate Bluetooth transmission paths in close proximity. Facilities are provided for muting all but a selected one of the activated channels during the time slot(s) when such collision is predicted to occur. Advantageously, such selection favors real-time or other high-priority traffic. The packets that would otherwise be transmitted over the muted channel(s) during the time slot (s) predicted for collision are locally buffered and thereafter selectively released when the muted channels are reactivated. Priority of resumption of transmission on the muted channels may be afforded on the basis of the relative ages or sizes of the packet content in their associated buffers.

### BACKGROUND OF THE INVENTION

This invention relates to packet transmission systems operating with Bluetooth transmission protocols and more particularly to Bluetooth-enabled devices employed in carrying out multi-channel transmission in such systems.

Bluetooth-enabled devices utilize spread-spectrum frequency hopping techniques to exchange packet data with other Bluetooth-enabled devices in a piconet after activation of radio connections (or channels) between radio modules associated with the respective devices. Pursuant to Bluetooth protocols, each device that initiates such connection thereafter communicates with associated correspondent devices through the transmission of packets of a unique channel hopping pattern in successive time slots. The frequency hops of each pattern in each successive time slot are distributed in a quasi-random manner within the Industrial-Scientific-Medical (ISM) band typically used for Bluetooth transmission.

Plural channels may be activated for simultaneous transmission to separate piconets by separate radio modules operating with different channel hopping patterns within the Bluetooth band. One concern with such arrangements is that the quasi-random distribution of frequency hops of each channel hopping pattern on the activated channels can result in certain time slots wherein the separate channels exhibit identical frequency hops. Such frequency “collisions” can lead to loss of transmitted information in the affected time slots.

One technique for addressing such collisions is set forth in applicants' copending application Ser. No. ______, filed ______, entitled “Frequency Hop Collision Prediction in a Multi-Channel, Bluetooth-Enabled Packet Transmission System” and assigned to the assignee of the present invention. Such application describes a technique for predicting a future time slot(s) within which such collisions are expected take place so that suitable means may be employed to abort such collisions.

### SUMMARY OF THE INVENTION

The present invention provides effective means for aborting such predicted collisions by permitting the transmission of packets over one of the activated channels during the time slot(s) when such collision is predicted to occur, and muting the rest of the colliding channels. In an illustrative embodiment, the packets that would otherwise be transmitted over the muted channel(s) during such time slot (s) are instead locally buffered and thereafter selectively released when the muted channel is reactivated.

One aspect of the invention involves the establishment of criteria for the selection of the channel that will continue to transmit during the muting period. In one example, the selection may be made on a random basis. In another example where a collision is predicted between a first channel carrying real-time or other high-priority traffic and other channels carrying non real- time or other lower priority traffic, the first channel may be selected for uninterrupted transmission. Priority of resumption of transmission on the muted channels after the occurrence of the predicted time slot(s) may be afforded on the basis of the relative ages or sizes of the packet content in their associated buffers.

### BRIEF DESCRIPTION OF THE DRAWING

These and other features, aspects and examples of the invention are further set forth in the following detailed description taken in conjunction with the appended drawing, in which:

FIG. 1 is a block diagram of a unitary, multiple-interface Bluetooth terminal provided with a radio manager for minimizing frequency hop collisions on the respective channels serviced by the interfaces of the terminal;

FIG. 2 is a block diagram illustrating the general arrangement of a radio manager employed in the terminal of FIG. 1; and

FIG. 3 is a block diagram of an adjustment circuit implemented in accordance with the invention and forming part of the radio manager of FIG. 2.

### DETAILED DESCRIPTION

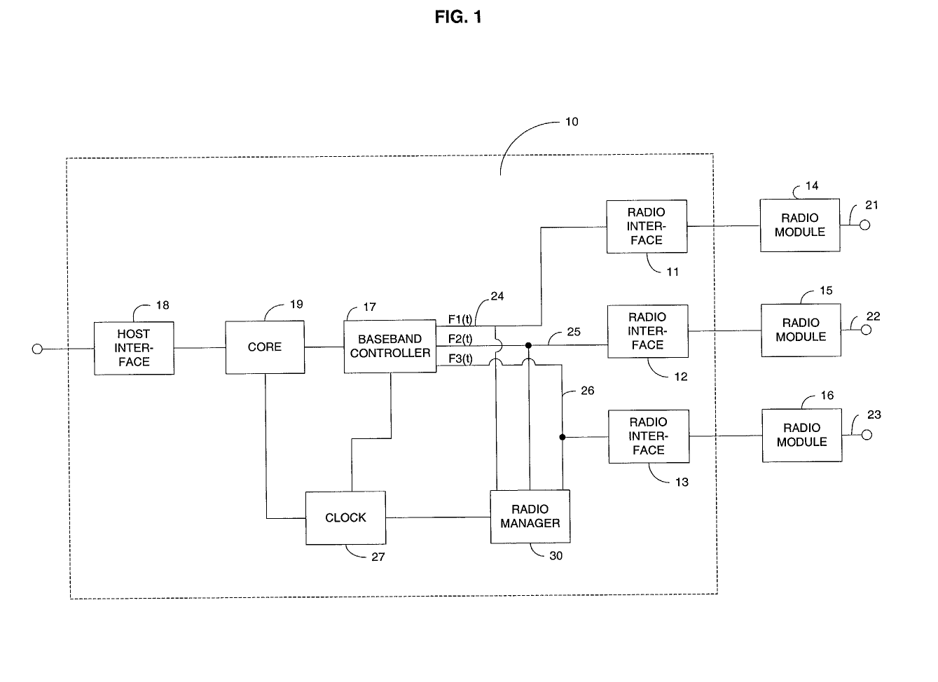

Referring now to the drawing, FIG. 1 illustratively depicts a Bluetooth-enabled terminal 10 having a plurality of co-located but independent radio interfaces, three of which are shown and identified with the numerals 11, 12 and 13, respectively. The interfaces 11-13 are individually coupled to external Bluetooth radio modules 14, 15 and 16 and to a common baseband controller 17. The controller 17, which receives packets to be transmitted through a host interface 18 and a CPU core 19, modulates the frequencies of the radio modules 14-16 with separate channel hopping patterns F1(t), F2(t) and F3(t) that conform to Bluetooth protocols. Such channel hopping patterns may be transmitted to associated corresponding Bluetooth devices (not shown) in different piconets over links or channels 21, 22 and 23, respectively.

Each of such channel hopping patterns illustratively exhibits, in each of its time slots, a quasi-randomly selected one of 79 different 1 MHz frequency hops within the ISM band. The respective patterns appear on outputs 24, 25 and 26 of the controller 17 and are respectively coupled to the radio modules 14-16 through the interfaces 11-13. Timing of the various logical operations within the terminal 10, including establishment and synchronization of the time slots for the patterns F1(t), F2(t) and F3(t), may be accomplished with the aid of a clock 27 coupled to the core 19 and the controller 17.

While not specifically illustrated in the drawing, the radio modules 14-16 are conventionally provided with facilities for transmitting, to the controller 17, counts originating from independent free-running clocks (not shown). Such free-running clocks, which illustratively are embodied by 28 bit counters having a clock rate centered at 3.2 KHz, are respectively associated with the particular master radio modules for the respective channels 21-23. ( In this connection, while it has been assumed that the modules 14-16 themselves are the master modules, it will be appreciated that in appropriate cases at least one of such channels may be set up in the opposite direction. In that case, the correspondent device for the associated one of the modules 14-16 would function as the master for such channel.)

The clock counts transmitted from the respective modules 14-16 to the controller 17 are employed by such controller to individually derive the channel hopping patterns F1(t), F2(t) and F3(t) on a one-to-one basis at the instant of establishment of the associated one of the channels 21-23.

The radio modules 14-16 may also be conventionally provided with facilities (not shown) for providing, to the controller 24, indications of unique, factory-set Bluetooth addresses of the master radio modules that have set up the channels 21-23. The controller also employs such unique addresses in the generation of the channel hopping patterns F1(t), F2(t) and F3(t).

Because the interfaces 11-13 and the associated radio modules 14-16 are in close proximity and independently support the respective channels 21-23, such channels are normally susceptible to frequency hop collisions in certain time slots. To confront such problem, the terminal 10 includes a radio manager 30 that includes, among other things, facilities for predicting in which future time slot(s) a collision of the corresponding channel hopping patterns F1(t), F2(t) and F3(t) will occur.

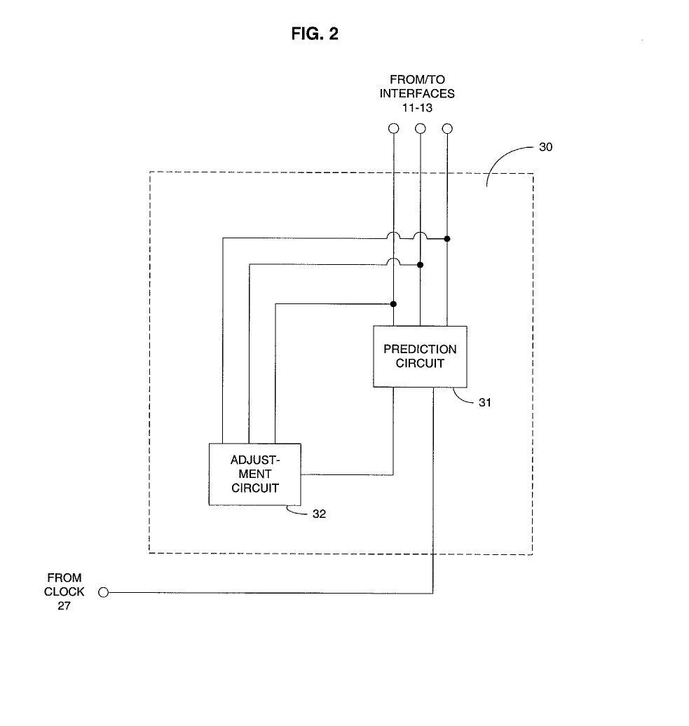

As illustrated in FIG. 2, the radio manager 30 includes for this purpose a prediction circuit 31 that is coupled to the clock 27 and to the interfaces 11-13. The prediction circuit 31 may contain suitable facilities for replicating future segments of the channel hopping patterns on the respective channels 21-23 (FIG. 1) and for comparing the frequency hops of such segments in corresponding time slots. From such comparison, the prediction circuit 31 (FIG. 2) generates a marker indicative of a future time slot(s) where the corresponding frequency hops of the respective channel hopping patterns coincide.

As discussed in more detail below, the radio manager 30 is further provided with facilities including an adjustment circuit 32 coupled to the output of the prediction circuit 31. The adjustment circuit 32 responds to a marker generated by such prediction circuit by altering the prospective frequency hops that would normally occur on selected colliding channel(s) during the predicted time slot(s) represented by the marker.

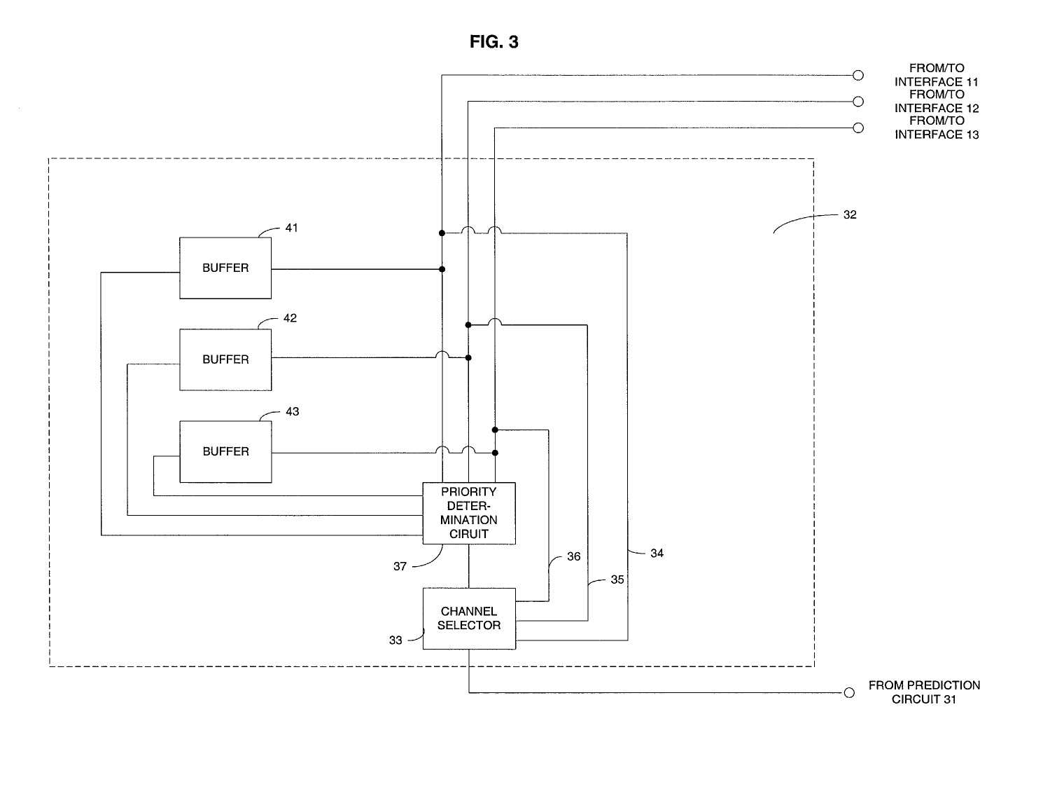

FIG. 3 depicts an embodiment of the adjustment circuit 32 implemented in accordance with the invention. Illustratively, the arrangement of FIG. 3 effects the desired frequency hop alteration by muting transmission on all but one of the colliding channels during the time slot predicted for collision by the prediction circuit 31.

Referring to FIGS. 1 and 3, the collision time slot marker at the output of the prediction circuit 31 is applied to a channel selector 33. Illustratively, the selector 33 converts the marker into a muting signal for the future time slot(s) represented by the marker and routes the generated muting signal to all but one of a plurality of outputs that are equal in number to the number of radio modules associated with the terminal 10. For the three-channel embodiment assumed in this description, such outputs are indicated at 34, 35 and 36 in FIG. 3. A decision as to which outputs of the selector 33 to direct the muting signal to is made by a priority determination circuit 37 as indicated below.

The selector outputs 34-36 are connected to the respective interfaces 11-13 associated with the radio modules 14-16. Assuming that the determination circuit 37 has chosen the outputs 35 and 36 of the selector 33, the muting signal from such selector is illustratively applied to the radio modules 15 and 16 through the interfaces 12 and 13. Such signal serves to mute the packets that would normally be transmitted by the modules 15 and 16 during the time slot(s) corresponding to the prediction marker. The muting of transmission of such packets during such time slot(s) will have the effect of removing the then-occurring frequency hops from the channels 22 and 23 governed by the radio modules 15 and 16. Accordingly, the collision that would normally take place between the frequency hops of such channels and of the still-activated channel 21 during such time slot(s) is effectively avoided.

The adjustment circuit 33 further includes packet buffers 41, 42 and 43 which are individually coupled to the interfaces 11-13 for respectively receiving and storing the packets that are not transmitted on the associated one of the channels 21-23 during a time slot when such transmission is muted. Assuming as before that the outputs 35 and 36 of the selector 33 are chosen by the priority determination circuit 37 to mute transmission through the interfaces 12 and 13, the buffers 42 and 43 associated with such interfaces will receive the packets normally slated for transmission over the channels 22 and 23 during the muting interval.

The determination circuit 37 is also coupled to the interfaces 11-13 to receive indications of the type of traffic that is being handled on each of the channels 21-23. (Conventionally, such indications may be implemented as responses to diagnostic queries applied to the respective channels by the determination circuit 37.) In general, the determination circuit 37 utilizes such responses to direct the selector 33 to route its muting signal to appropriate pairs of the outputs 34-36 either on a random basis or on basis of one of several priority criteria applicable to the responses obtained from the channels 21-23 through the interfaces 11-13. For example, if such responses indicate that the channel 21 is then carrying relatively high priority traffic (e.g., real time information such as voice) while the channels 22 and 23 are carrying relatively low priority traffic (e.g., non-real time information), the determination circuit 37 can direct the selector 33 to activate its outputs 35 and 36. This will serve to route the muting signal from the selector 33 to the radio modules 15 and 16 through the respective interfaces 12 and 13, and thereby mute transmission of the lower priority packets on the channels 22 and 23 during the time slot(s) predicted for collision by the prediction circuit 31. As indicated above, any such muted packets will be stored in the associated buffers (in this case, the buffers 42 and 43), to be released after the muting period has ended.

The determination circuit 37 is also coupled to each of the buffers 41-43 to receive separate indications of a selected characteristic of the packet content in each buffer. Utilizing such arrangement, the determination circuit 37 may prioritize the reactivation of the muted channels 22 and 23 after the muting period is ended. Illustratively, the determination circuit 37 may direct the selector 33 to sequentially remove the muting signal from the muted radio modules 22 and 23 in accordance with the relative sizes or ages of the packet content stored in the associated collision buffers 42 and 43. For example, if both of the muted channels 22 and 23 are carrying real-time traffic, the sequence in which to reactivate such channels may be determined by the relative age of the content of the packets in the associated buffers, with the oldest content being released first. If, on the other hand, both of such muted channels are carrying non-real-time traffic, the sequence in which to reactivate such channels may be determined by the relative size of the content of the packets in the associated buffers, with the largest content being released first.

In the foregoing, the invention has been described in connection with illustrative implementations thereof. Many variations and modifications will now occur to those skilled in the art. For example, prioritization of muting/reactivation of the channels 21-23 can be determined on the basis of the relative quality of service on the channels in question. Also, while for clarity of description the terminal 10 of FIG. 1 utilizes three radio interfaces to service a corresponding number of channels, it will be understood that any reasonable number of such interfaces and channels may be used. In addition, while the adjustment circuit 33 has been described in connection with one illustrative arrangement for avoiding frequency-hop collision during transmission through such radio interfaces, it will be understood that other equivalent means may be employed for this purpose. It is accordingly desired that the scope of the appended claims not be limited to or by the specific disclosure herein contained.

What is claimed is:

1. For use in a system for effecting packet communication over a plurality of separate transmission paths each adapted to connect separate Bluetooth-enabled elements, the paths each being implemented to transmit packets in independent channel hopping patterns that exhibit quasi-random frequencies in discrete time slots, a method of avoiding transmission interference between the paths, which comprises the steps of:
predicting a first future time slot(s) when the frequency hops of the respective channel hopping patterns will coincide; and
muting the transmission of packets over a first subset of the paths during the predicted time slot(s).

2. A method as defined in claim 1, in which the first subset includes all but one of the paths.

3. A method as defined in claim 1, in which the first subset is selected at random.

4. A method as defined in claim 1, in which the first subsets contains the path(s) carrying traffic having a then-lower priority of transmission.

5. A method as defined in claim 1, in which at least one of the paths carries real-time traffic and the other path(s) carry non real-time traffic, and in which the first subset contains the path(s) carrying non real-time traffic.

6. For use in a system for effecting packet communication over at least three separate transmission paths each adapted to connect separate Bluetooth-enabled elements, the paths each being implemented to transmit packets in independent channel hopping patterns that exhibit quasi-random frequencies in discrete time slots, a method of avoiding transmission interference between the paths, which comprises the steps of:
predicting a first future time slot(s) when the frequency hops of the respective channel hopping patterns will coincide;
muting the transmission of packets over a plurality of first ones of the paths during the predicted time slot(s), the number of first paths being less than the total number of paths;
storing, during the predicted time slot(s), the packets normally transmitted over each of the first paths; and
releasing the stored packets for transmission over the corresponding first paths after the occurrence of the predicted time slot(s).

7. A method as defined in claim 6, in which the releasing step is carried out with a sequential release of the stored packets, the stored packets having the oldest content being released first.

8. A method as defined in claim 7, in which each of the first paths carries real time traffic.

9. A method as defined in claim 6, in which the releasing step is carried out with a sequential release of the stored packets, the stored packets having the largest content being released first.

10. A method as defined in claim 9, in which each of the first paths carries non real-time traffic.

11. A Bluetooth-enabled terminal comprising:
a core;
a plurality of radio interfaces associated with the core for independently supporting a plurality of Bluetooth radio modules;
a baseband controller coupled to the radio interfaces for normally effecting packet transmission from the associated radio modules with independent channel hopping patterns in which the packets exhibit quasi-random frequencies in discrete time slots:
means for predicting a future time slot(s) when the frequency hops of the respective channel hopping patterns will coincide; and
means for muting the transmission of packets from a first subset of the radio modules during the predicted time slot(s).

12. A terminal as defined in claim 11, in which the first subset includes all but one of the radio modules.

13. A terminal as defined in claim 11, in which the muting means comprises, in combination, a plurality of buffers individually associated with the respective radio modules; means for storing, in the buffer(s) associated with the radio module(s) in the first subset, the packets whose transmission is muted over the predicted time slot(s); and means for releasing the stored packets in such buffer(s) for transmission from the radio module(s) in the first subset after the occurrence of the predicted time slot(s).

14. In a system for effecting packet communication over a at least three separate transmission paths each adapted to connect separate Bluetooth-enabled elements, the paths each being implemented to transmit packets in independent channel hopping patterns that exhibit quasi-random frequencies in discrete time slots, apparatus for avoiding transmission interference between the paths, which comprises the steps of:
means for predicting a first future time slot(s) when the frequency hops of the respective channel hopping patterns will coincide;
means for muting the transmission of packets over a plurality of first ones of the paths during the predicted time slot(s), the number of first paths being less than the total number of paths;
means for storing, during the predicted time slot(s), the packets normally transmitted over each of the first paths; and
means for subsequently releasing the stored packets for transmission over the corresponding first paths in a sequence determined by a selected characteristic of the stored packets.

15. Apparatus as defined in claim 14, in which the selected characteristic is the relative age of the contents of the respective packets.

16. Apparatus as defined in claim 14, in which the selected characteristic is the relative size of the contents of the respective packets.
